(19) United States
(12) Patent Application Publication
(10) Pub. No.: US 2008/0238647 A1
(43) Pub. Date: Oct. 2, 2008

(54) VEHICLE INCLUDING SEAT BELT

(76) Inventor: Shinya Abe, Miyagi-ken (JP)

Correspondence Address: BRINKS HOFER GILSON & LIONE, P.O. BOX 10395, CHICAGO, IL, 60610, US

(21) Appl. No.: 12/054,059

(22) Filed: Mar. 24, 2008

(30) Foreign Application Priority Data
Mar. 27, 2007 (JP) 2007-081524

(51) Int. Cl. B60Q 1/00

(52) U.S. Cl. 340/457.1

(57) ABSTRACT

The disclosure provides a vehicle including a seat belt that is brought into a fastened state as fastening operation is performed through preliminary operation that is performed before the seat belt is fastened. The vehicle includes a first transmitter that transmits a predetermined signal by radio when the fastening operation is detected, a second transmitter that transmits a predetermined signal by radio when the preliminary operation is detected, a receiver that receives the signal from the first transmitter and the signal from the second transmitter, and a control section that determines the fastened state of the seat belt on the basis of the signals received by the receiver. The state of the receiver is switched from an intermittent operation state to a continuous operation state as the signal from the second transmitter is received. The control section determines that the seat belt has been fastened when the receiver receives the signal from the first transmitter after the reception of the signal from the second transmitter.

This application claims benefit of Japanese Patent Application No. 2007-0181524 filed on Mar. 27, 2007, which is hereby incorporated in its entirety by reference.

### BACKGROUND

1. Field of the Invention

The present invention relates to a vehicle including a seat belt that is brought into a fastened state as fastening operation is performed through preliminary operation that is performed before the seat belt is fastened, and particularly, to a vehicle in which a signal is transmitted by radio from a seat belt at the time of fastening, and determination of the fastening is made.

2. Description of the Related Art

Conventionally, a technique of detecting and displaying the fastened state of a seat belt provided in a vehicle is known. In this case, detection of the fastened state is made by a buckle switch disposed in a buckle device constituting the seat belt. If the buckle switch has detected that the seat belt is in a fastened state, a signal is sent by wire to a control section of the vehicle from the seat belt, thereby performing control, such as display.

However, in vehicles, such as recreational vehicles (RV), in which some of seats are detachable, a seat belt of each of the detachable seats is provided in the seat itself. Therefore, it is difficult to connect to the seat belt a signal line to be connected to the vehicle side or a wiring line for power feeding. For this reason, a technique of transmitting a signal by wireless communication from the seat belt side if fastening is detached is considered. As a vehicle including such a seat belt, there is, for example, one mentioned in Japanese Unexamined Patent Application No. 2001-211.

In a case where a signal is transmitted by wireless communication, a receiver that receives the signal on the side of a vehicle should be in a state where it can receive a signal always. However, if the receiver is always in a continuous operating state, a large amount of electric power is consumed. It is thus considered that the receiver is normally brought into an intermittent operation state, the state of the receiver shifts to a continuous operation state upon receiving a predetermined signal from the seat belt side, and it is then determined on the vehicle side that a seat belt is in a fastened state as a signal including the fact that the seat belt is brought into a fastened state is received from the seat belt side. However, when a signal for shifting the state of the receiver to the continuous operation state by detection of fastening is transmitted, and then, a signal including the fact that the receiver is brought into a fastened state is transmitted, a certain period of time is actually required from the fastening to determination of the fastening on the vehicle side. As a result, a problem that responsiveness is not good occurs.

### SUMMARY

A vehicle includes a seat belt that is brought into a fastened state as fastening operation is performed through preliminary operation that is performed before the seat belt is fastened. The vehicle includes: a first transmitter that transmits a predetermined signal by radio when the fastening operation of the seat belt is detected; a second transmitter that transmits a predetermined signal by radio when the preliminary operation before the fastening of the seat belt is detected; a receiver that receives the signal from the first transmitter and the signal from the second transmitter; and a control section that determines the fastened state of the seat belt on the basis of the signals received by the receiver. The state of the receiver is switched from an intermittent operation state to a continuous operation state as the signal from the second transmitter is received. The control section determines that the seat belt has been fastened when the receiver receives the signal from the first transmitter after the reception of the signal from the second transmitter.

### BRIEF DESCRIPTION OF THE DRAWINGS

FIG. 1 is a schematic view of a vehicle in this embodiment;

FIG. 2 is a perspective view of a fastening portion of a seat belt;

FIG. 3 is a perspective view of a winding portion of the seat belt;

FIG. 4 is a block diagram of the configuration for transmitting and receiving a signal;

FIG. 5 is a flow diagram of the operation at the time of seat belt fastening;

FIG. 6 is a flow diagram of the operation at the time of seat belt unfastening;

FIG. 7 is a chart view showing the state of respective components with the lapse of time at the time of the fastening of the seat belt; and

FIG. 8 is a chart view showing the state of the respective components with the lapse of time at the time of the unfastening of the seat belt.

### DESCRIPTION OF THE EMBODIMENTS

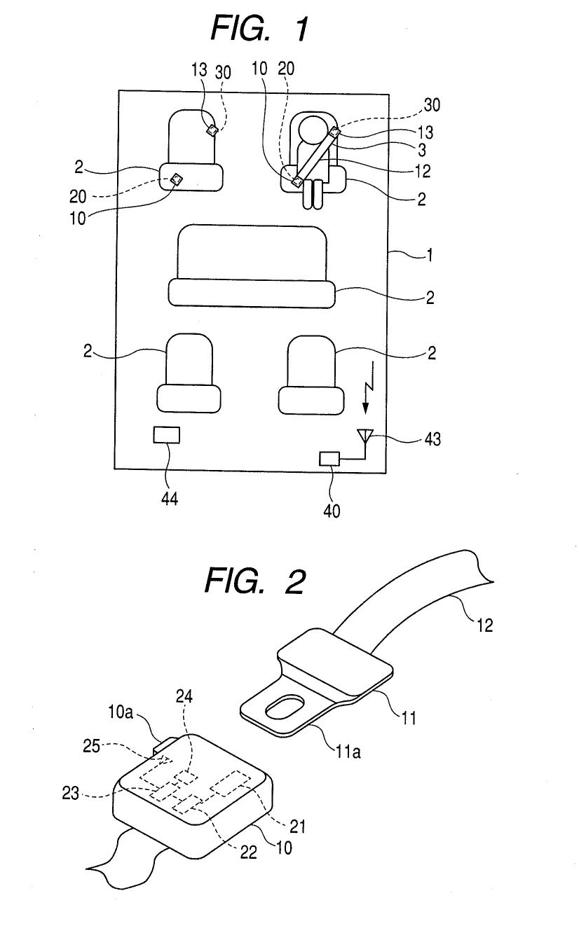

An embodiment of the invention will be described in detail with reference to the drawings. A schematic view of a vehicle in this embodiment is shown in FIG. 1. As shown in this drawing, the vehicle 1 in this embodiment includes a plurality of seats 2 therein. The seats 2 are provided in three rows in the vehicle. Among them, a rearmost row of the seats 2 is detachable. A space formed by detaching these seats 2 can also be used as a luggage compartment. Each of the detachable seats 2 in the rearmost row is provided with a seat belt 3.

The seat belt 3 provided in the seat 2 itself is configured such that a belt 12 is pulled out from a winding portion 13 provided at the shoulder of a person who sits down on the seat 2 toward a buckle portion 10 provided in the vicinity of the waist of the person. The buckle portion 10 is provided with a first transmitter 20, and the winding portion 13 is provided with a second transmitter 30. These transmitters transmit a predetermined signal by radio at the time of fastening or unfastening of the seat belt 3.

As for this seat belt 3, at the time of fastening, the fastening of the seat belt 3 is completed as the preliminary operation of pulling out the belt 12 is first performed, and the fastening operation of inserting a tongue portion 11 provided at the tip of the belt 12 into the buckle portion 10. Further, in a case where the seat belt 3 is unfastened, the operation of detaching the tongue portion 11 from the buckle portion 10 is first performed, and the operation of winding the belt 12 toward the shoulder is then performed. In order to match the names of these operations with those of the operations at the time of fastening, the operation of the detaching the tongue portion 11 from the buckle portion 10 is hereinafter referred to as releasing operation, and the operation of winding the belt 12 is hereinafter referred to as preliminary operation.

Further, the vehicle 1 has a receiver 40 that receives a signal transmitted from the first transmitter 20 or the second transmitter 30, and a display section 44 that displays the fastened state of the seat belt 3 that is a determination result based on the received signal. Other configurations will be described below.

A perspective view of a fastening portion of the seat belt 3 is shown in FIG. 2. The seat belt 3 has the tongue portion 11 attached to the tip of the belt 12, and the buckle portion 10 that allows a metallic inserted portion 11a formed at the tip of the tongue portion 11 to be inserted thereinto, and to be engagingly fixed thereto.

The buckle portion 10 is formed substantially in the shape of a box in appearance, and a side face of buckle portion is provided with a buckle release button 10a that can be held down. When the buckle release button 10a is operated with the inserted portion 11a of the tongue portion 11 being inserted into and fixed to the buckle portion 10, the engagement state of the tongue portion 11 with respect to the inserted portion 11a is released, which allows the tongue portion 11 to be detached from the buckle portion 10.

Further, as a configuration for transmitting a signal toward the vehicle 1 at the time of insertion or detachment of the tongue portion 11, a power generation section 21, a charge section 22, a first control section 23, a sensor 24, and an antenna 25 are built in the buckle portion 10. The power generation section 21 has a piezoelectric element, and an impact imparting mechanism (both of them is not shown) that applies impact to the piezoelectric element with insertion and detachment of the tongue portion 11, and converts the energy of the impact caused with the insertion and detachment of the tongue portion 11 into electric power, and uses this electric power for transmission of a signal. The charge section 22 commutates and temporarily stores electric power generated in the power generation section 21, and supplies the electric power to the first control section 23 or the like.

The sensor 24 detects the insertion and detachment of the tongue portion 11 into and from the buckle portion 10, and thereby, the first control section 23 can recognize either the insertion or detachment. The first control section 23 transmits a predetermined signal from the antenna 25 when the tongue portion 11 has been inserted into or detached from the buckle portion 10.

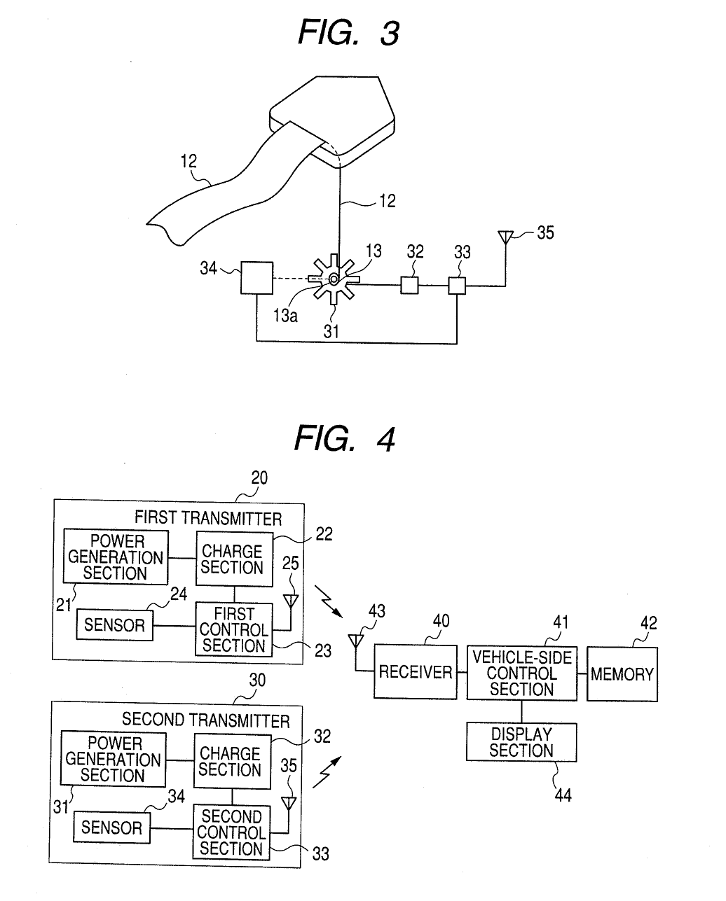

A perspective view of the winding portion of the seat belt 3 is shown in FIG. 3. The winding portion 13 is provided at the end of the seat belt 3 opposite the tongue portion 11 of the belt 12, and is adapted to be capable of winding the belt 12 in a state where the fixation of the buckle portion 10 and the tongue portion 11 has been released. The winding portion 13 is provided with a rotary shaft 13a for winding the belt 12, and a power generation section 31 that converts the rotational motion of the rotary shaft into electric power is attached to the winding portion. In addition, the power generation section 31 has a second impact mechanism at the periphery of which projections are provided intermittently, and a piezoelectric element, and generates electricity as the projections strike the piezoelectric element one after another with the rotation of the rotary shaft 13a.

Further, similarly to the buckle portion 10 side, in addition to the power generation section 31, a charge section 32, a second control section 33, a sensor 34, and an antenna 35 are provided even on the side of the winding portion 13. The function of the charge section 32 is the same as that of the charge section 22 on the side of the buckle portion 10. Further, the sensor 34 detects, for example, the rotation of the rotary shaft for winding the belt 12, and thereby, the second control section 33 can discriminate whether the belt 12 is wound up or pulled out, and recognize the amount of winding or the amount of pull-out. The second control section 33 transmits a predetermined signal from the antenna 35 when the belt 12 has been wound up or pulled out.

A block diagram of the configuration for transmitting and receiving a signal is shown in FIG. 4. The first transmitter 20 shown in FIG. 4 is provided on the side of the buckle portion 10 of the seat belt 3, the second transmitter 30 shown in FIG. 4 is provided on the side of the winding portion 13 of the seat belt 3, and other devices than the receiver 40 are provided on the side of the vehicle 1 as shown also in FIG. 1.

The first transmitter 20, as mentioned above, has the power generation section 21, the charge section 22, the first control section 23, the sensor 24, and the antenna 25. Further, the second transmitter 30, as mentioned above, has the power generation section 31, the charge section 32, the second control section 33, the sensor 34, and the antenna 35. From the first transmitters 20 and the second transmitter 30, signals are transmitted by radio toward the vehicle 1, using electric power generated in the power generation sections 21 and 31, respectively.

A signal transmitted from the first transmitter 20 or the second transmitter 30 is received by the receiver 40 having an antenna 43, which is provided on the side of the vehicle 1, and the fastened state of the seat belt 3 is determined by a vehicle-side control section 41. The determination result is stored in a memory 42 connected to the vehicle-side control section 41. The vehicle-side control section 41 displays the fastened state of the seat belt 3 on the display section 44 with reference to the memory 42 when the display section is allowed to display a state, for example, by start of an engine.

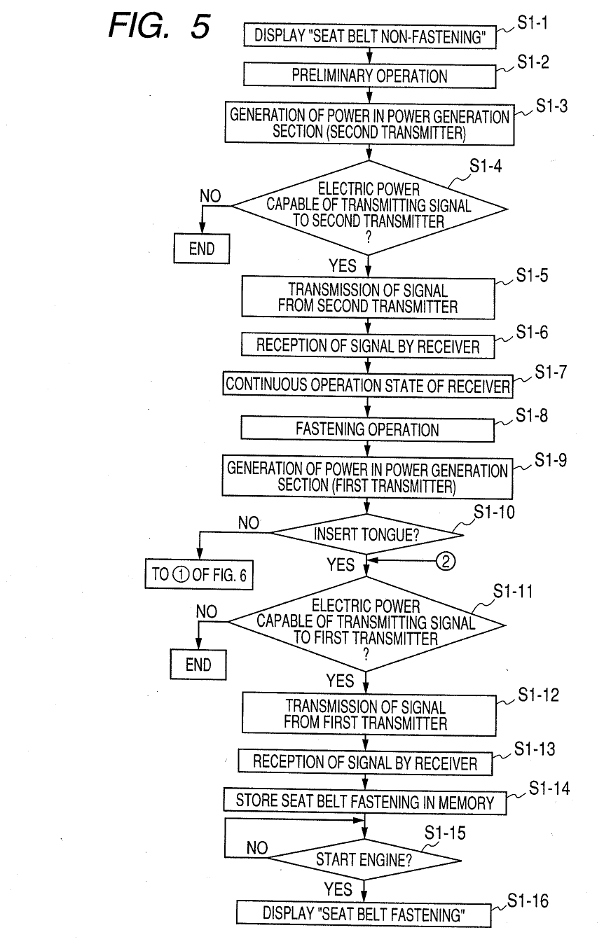

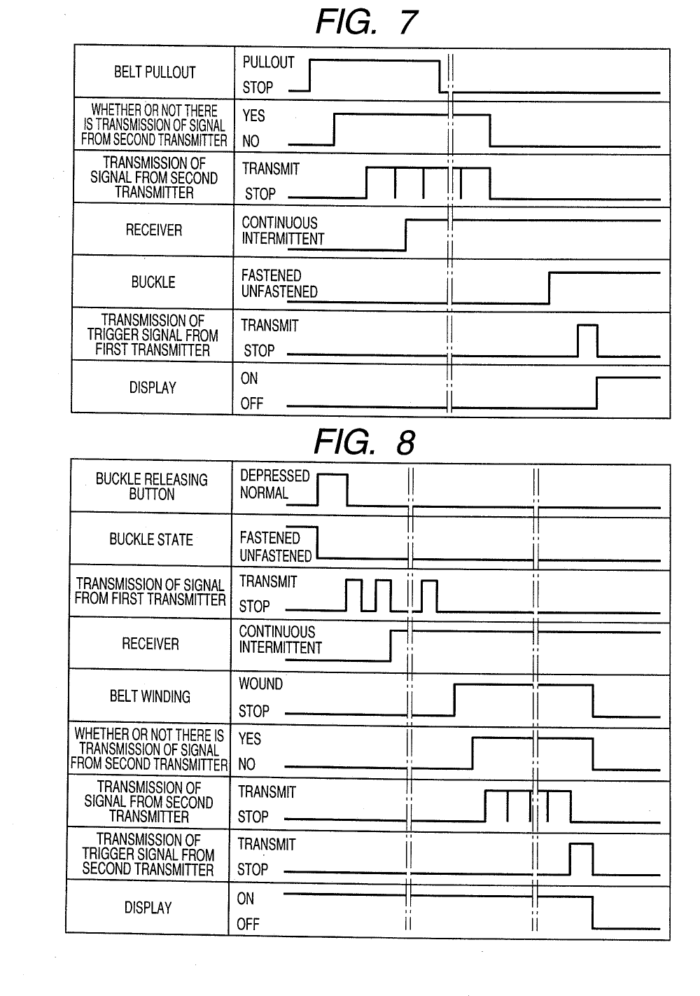

Next, the flow of operation of each device at the time of fastening of the seat belt 3 will be described. The flow of operation at the time of fastening of a seat belt is shown in FIG. 5, and a chart view showing the state of the respective components with the lapse of time at the time of the fastening of the seat belt is shown in FIG. 7. Before the fastening of the seat belt, as shown in S1-1 of FIG. 5, the state where the display section 44 displays shall be “SEAT BELT NON-FASTENING.” This flow assumes that the seat belt 3 is fastened after the engine has stopped. Accordingly, at this point of time, display in the display section 44 is not performed actually.

) Here, when the preliminary operation of pulling out the belt 12 is performed (S1-2), power is generated in the power generation section 31 of the second transmitter 30 provided on the side of the winding portion 13 (S1-3). When the pull-out of the belt 12 is started, electric power is gradually stored in the charge section 32, and when predetermined time has lapsed from the pull-out of the belt 12 as shown in FIG. 7, electric energy that is sufficient for transmission of a signal from the second transmitter 30 is stored. If predetermined time has lapsed from the pull-out of the belt 12, the second control section 33 of the second transmitter 30 determines whether electric power that is sufficient for transmission of a signal to the second transmitter 30 has been stored by referring to an input voltage from the charge section 32 (S1-4). In a case where sufficient electric power is not stored, the flow is ended at that moment. On the other hand, in a case where sufficient electric power is stored, the process proceeds to the next step.

Next, a predetermined signal is transmitted from the second transmitter 30 (S1-5). As mentioned above, since this flow assumes the state where the engine has stopped, the receiver 40 of a vehicle 1 operates intermittently in order to reduce its power consumption. In order to change the state of the receiver 40 from an intermittent operation state to a continuous operation state, it is necessary to receive a preamble signal transmitted from the second transmitter 30. Then, as shown in FIG. 7, signals including the preamble signal are repeatedly transmitted from the second transmitter 30 predetermined times. Further, following the preamble signal, data signals including information that identifies whether a signal is transmitted from a certain seat 2, information on whether the seat belt 3 is pulled out or wound again, which is detected by the sensor 34, and ID information set uniquely in the vehicle 1, are transmitted every time.

The receiver 40 on the side of the vehicle 1 receives the signal transmitted from the second transmitter 30 (S1-6). By the preamble signal included in the signal transmitted by the second transmitter 30, the state of the receiver 40 is switched from an intermittent operation state to a continuous operation state (S1-7) Although FIG. 7 shows that the receiver 40 reaches a continuous reception state as the receiver receives the first signal among signals transmitted from the second transmitter 30, it is sufficient if the receiver 40 can receive any one signal among signals that are transmitted multiple times.

When the pulled-out seat belt 3 performs fastening operation, that is, the tongue portion 11 is inserted into and is engagingly fixed to the buckle portion 10 (S1-8), power is generated in the power generation section 21 of the first transmitter 20 provided on the side of the buckle portion 10 (S1-9) Here, the first control section 23 of the first transmitter 20 determines whether insertion of the tongue portion 11 has been detected by the sensor 24 (S1-10). In a case where it is determined that there is no insertion of the tongue portion 11, that is, the tongue portion 11 has been detached, the process proceeds to the flow at the time of the unfastening of the seat belt to be described later. In a case where it is determined that there is insertion of the tongue portion 11, the process proceeds to the next step.

Next, the first control section 23 of the first transmitter 20 determines whether electric power that is sufficient for transmission of a signal to the first transmitter 20 has been stored by referring to an input voltage from the charge section 22 (S1-11). In a case where sufficient electric power is not stored, the flow is ended at the point of time. On the other hand, in a case where sufficient electric power is stored, the process proceeds to the next step.

Next, a predetermined signal is transmitted from the first transmitter 20 (S1-12). From the first transmitter 20, a short signal showing that the fastening operation has been made is transmitted. The electric power obtained in the power generation section 21 as the tongue portion 11 is inserted into the buckle portion 10 is smaller than the electric power obtained in the power generation section 31 as the belt 12 is pulled out. That is, since the tongue portion 11 is short, the relative travel distance between the tongue portion and the buckle portion from the start of insertion of the tongue portion into the buckle portion to the completion of fastening of the tongue portion can be lengthened. For the reason, since only slight movement of an impact imparting mechanism can be expected at the time of insertion or release, and it is also difficult to make impact force large because a person inserts the tongue portion, it is difficult to make electric power large. On the other hand, at the time of the pull-out or winding operation of the belt 12, the seat belt 12 is long, and electricity can be generated for a long time. For the reason, large electric power can be generated as compared with that at the time of insertion or release. For this reason, positive signal transmission can be performed. Because the time required to transmit can be reduced by making the amount of data of signals transmitted by the first transmitter 20 smaller than signals transmitted by the second transmitter 30.

The signal transmitted from the first transmitter 20 is received by the receiver 40 (S1-13) When the signal from the first transmitter 20 is received, the vehicle-side control section 41 determines that the seat belt 3 is in a fastened state, and makes the fact of being in the fastened state stored in the memory 42 (S1-14). Then, when an engine is started (S1-15), the vehicle-side control section 41 displays the fact that a seat belt is fastened on the display section 44 with reference to the memory 42 (S1-16).

As described above, by the preliminary operation of seat belt fastening that is performed previously in time, signals including a preamble signal from the second transmitter 30 are transmitted, and the state of the receiver 40 is switched from an intermittent operation state to a continuous operation state. Thereafter, by the fastening operation that the tongue portion 11 is inserted into the buckle portion 10, a signal indicating the fastening operation is transmitted from the first transmitter 20, and the vehicle-side control section 41 that has received the signal determines that a seat belt is fastened. Thereby, the determination can be immediately performed from the fastening operation of the seat belt 3. Thus, it is possible to obtain a system with good responsiveness to the fastening operation of the seat belt 3. That is to say, the receiver 40 can be switched from the intermittent operation state to the continuous operation state at the point of time of the preliminary operation that is performed previously in time, and it can be determined that the seat belt has been fastened immediately after the fastening operation is performed. Thus, the fastened state of the seat belt can be rapidly detected by wireless communication on the vehicle side. Further, in the preliminary operation where a relatively large amount of electricity generated can be secured, signals including a preamble signal and a data signal are transmitted multiple times. In the fastening operation with little electricity generated, a short signal serving as a trigger that performs determination in the vehicle-side control section 41 is transmitted. Thus, signal transmission can be performed positively, using electric power generated in each operation. That is to say, electric power required for transmission at the time of fastening operation with small operation can be made small.

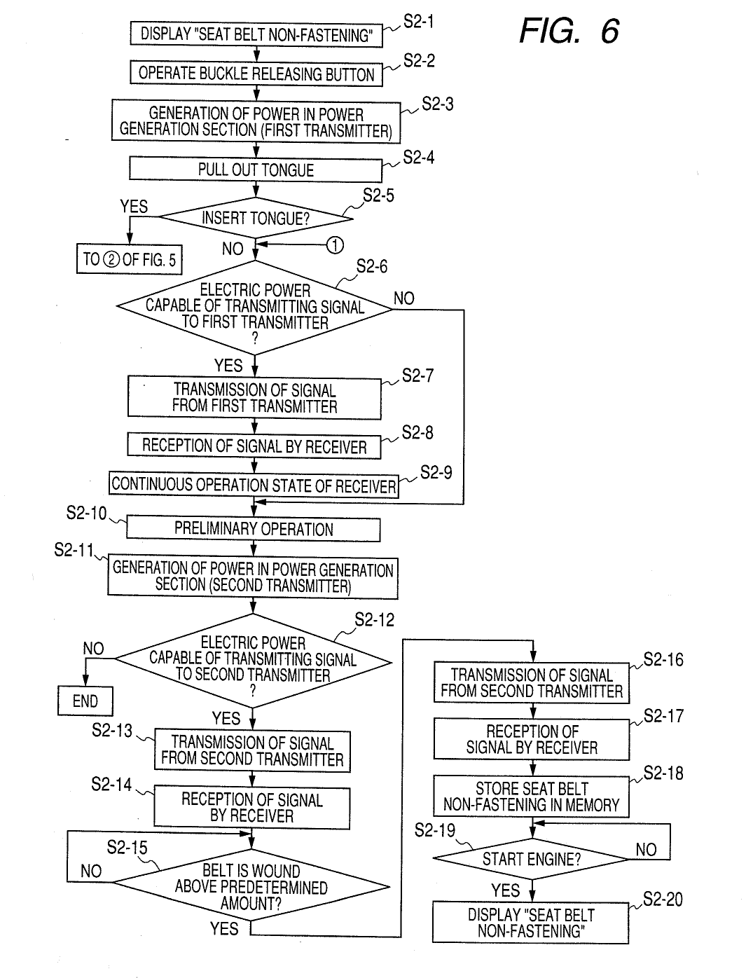

Moreover, a power generation section 21 (a first power feeder) that generates electricity by the fastening operation of the seat belt, and feeds electric power to the first transmitter 20, and a power generation section 31 (a second power feeder) that generates electricity by the preliminary operation of the seat belt 12, and feeds electric power to the second transmitter 30. Thereby, a signal can be transmitted without providing a battery, etc., and transmission of a signal is shared at the preliminary operation and fastening operation. Thus, even if electricity generated is small, positive signal transmission can be performed. Next, the flow of operation of each device at the time of unfastening of the seat belt 3 will be described. A flow diagram of operation at the time of unfastening of a seat belt is shown in FIG. 6, and a chart view showing the state of the respective components with the lapse of time at the time of the unfastening of the seat belt is shown in FIG. 8. In a state where the seat belt 3 is fastened, as shown in S2-1 of FIG. 6, the state where the display section 44 displays shall be “SEAT BELT FASTENING.”

Here, when the buckle release button 10a is operated, that is, the releasing operation is performed (S2-2), power is generated in the power generation section 21 of the first transmitter 20 provided on the side of the buckle portion 10 (S2-3). As shown in FIG. 8, the state of the buckle portion 10 becomes a state where the engagement of the tongue portion 11 is released as the buckle release button 10a is held down. Subsequently, when the tongue portion 11 is pulled out of the buckle portion 10 (S2-4), the first control section 23 of the first transmitter 20 determines whether the insertion of the tongue portion 11 has been detected by the sensor 24 (S2-5). In a case where it is determined that there is the insertion of the tongue portion 11, the process proceeds to the flow at the time of the above-mentioned seat belt fastening. In a case where it is determined that there is no insertion of the tongue portion 11, the process proceeds to the next step.

Next, the first control section 23 of the first transmitter 20 determines whether electric power that is sufficient for transmission of a signal to the first transmitter 20 has been stored by referring to an input voltage from the charge section 22 (S2-6). In a case where sufficient electric power is not stored, the first transmitter 20 does not perform operation any more, and proceeds to Step S2-10. On the other hand, in a case where sufficient electric power is stored, the process proceeds to Step S2-7.

Subsequently, a predetermined signal is transmitted from the first transmitter 20 (S2-7). Here, trigger signals for changing the intermittent operation state of the receiver 40 to a continuous operation state are transmitted multiple times. These trigger signals are made shorter than the above-mentioned preamble signal. The receiver 40 receives any of the trigger signals that are transmitted multiple times (S2-8), whereby the state thereof shifts from the intermittent operation state to the continuous operation state (S2-9).

Subsequent the releasing operation, the operation of winding the belt 12, i.e., the preliminary operation, is performed (S2-10). When the belt 12 is wound, power is generated in the power generation section 31 of the second transmitter 30 provided on the side of the winding portion 13 (S2-11). When the winding of the belt 12 is started, electric power is gradually stored in the charge section 32, and after predetermined time has lapsed as shown in FIG. 8, electric energy that is sufficient for transmission of a signal from the second transmitter 30 is stored. If predetermined time has lapsed from the winding of the belt 12, the second control section 33 of the second transmitter 30 detects whether electric power required for signal transmission has been stored (S2-12). In a case where sufficient electric power is not stored, the flow is ended directly. In a case where sufficient electric power is stored, a predetermined signal is transmitted from the second transmitter 30 (S2-13).

Here, the signals transmitted from the second transmitter 30 include a preamble signal and a data signal, and as shown in FIG. 8, they are transmitted multiple times. Since the first transmitter 20 cannot transmit a signal due to lack of electricity generated, or the receiver 40 cannot detect a trigger signal from the first transmitter 20, the receiver 40 may be in the intermittent operation state even at this point of time. Therefore, the preamble signal is transmitted in order to positively shift the state of the receiver from the intermittent operation state to the continuous operation state. In addition, the preamble signal is disregarded in a case where the receiver 40 is already in the continuous operation state by a signal from the first transmitter 20.

The receiver 40 on the side of the vehicle 1 receives the signal transmitted from the second transmitter 30 (S2-14). Next, if the fact that the belt 12 has been wound up more than a predetermined distance (S2-15) is recognized in the second control section 33 by the sensor 34, the second transmitter 30 transmits a short signal showing that the preliminary operation has been performed (S2-16). When the receiver 40 receives this signal (S2-17), the vehicle-side control section 41 makes the fact that the seat belt 3 is in a non-fastened state stored in the memory 42 (S2-18). Furthermore, if an engine is in a driven state (S2-19), the vehicle-side control section 41 makes the display section 44 display the fact that a seat belt is not fastened (S2-20).

As described above, even at the time of the seat belt unfastening, a trigger signal for switching the operating state of the receiver 40 is transmitted from the first transmitter 20 by the releasing operation that is performed previously in time. Thereafter, by the preliminary operation that the belt 12 is wound up, a signal indicating the preliminary operation is transmitted from the second transmitter 30, and the vehicle-side control section 41 that has received the signal determines that a seat belt is unfastened. Thereby, the determination can be immediately performed as fastening of the seat belt 3 is released and wound up. Thus, it is possible to obtain a system with good responsiveness.

Further, in the preliminary operation where a relatively large amount of electricity generated can be secured, signals including a preamble signal and a data signal are transmitted multiple times. In the releasing operation with little electricity generated, a short signal for switching the operating state of the receiver 40 is transmitted. Thus, signal transmission can be performed positively, using electric power generated in each operation.

Although the embodiment of the invention has been described hitherto, application of the invention is not limited to the embodiment, and the invention is applied in various ways within the scope of the technical idea of the invention. For example, in this embodiment, the seats 2 are provided in three rows in the vehicle 1, the first transmitter 20 and the second transmitter 30 are provided only in the seats 2 in the rearmost row so as to perform wireless communication in the fastened state of a seat belt 3. However, the arrangement of the seats 2, and whether each transmitter is provided in a certain seat 2 can be suitably set if required.

Further, in this embodiment, the pull-out or winding operation of the belt 12 is considered as preliminary operation, and the operation after a seat belt non-fastened state in a state where a person sits down on a seat is considered as preliminary operation. In addition to these operations, however, a sit-down operation with respect to a seat 2 or an opening and closing operation of a door may be considered as the preliminary operation. Otherwise, in a case where a keyless entry system is included, and position determination of a portable device is performed, it may be detected that the preliminary operation has been performed as the portable device is carried into a vehicle from the outside of the vehicle. In short, operations that are inevitably performed before fastening of the seat belt 12 can be considered as the preliminary operation.

Moreover, in this embodiment, the first transmitter 20 and the second transmitter 30 are provided with the power generation sections 21 and 31, respectively. However, a power feed system for feeding electric power is not limited thereto. A battery or the like may be provided in the first transmitter 20 to supply electric power, and supply of electric power of the second transmitter may be performed from a battery of a vehicle. In addition, the supply of electric power of the second transmitter can be performed from a battery in a case where seat belts, such as a driver's seat and a passenger seat, are provided in a main body of a vehicle. However, in a case where a seat is integral with the main body, like rear seats, the supply of electric power of the second transmitter is not suitable because wiring becomes complicated. Thus, it is better to generate electric power as in this embodiment.

1. A vehicle including a seat belt that is brought into a fastened state as fastening operation is performed through preliminary operation that is performed before the seat belt is fastened, the vehicle comprising:
a first transmitter that transmits a predetermined signal by radio when the fastening operation of the seat belt is detected;
a second transmitter that transmits a predetermined signal by radio when the preliminary operation before the fastening of the seat belt is detected;
a receiver that receives the signal from the first transmitter and the signal from the second transmitter; and
a control section that determines the fastened state of the seat belt on the basis of the signals received by the receiver,
wherein the state of the receiver is switched from an intermittent operation state to a continuous operation state as the signal from the second transmitter is received, and
wherein the control section determines that the seat belt has been fastened when the receiver receives the signal from the first transmitter after the reception of the signal from the second transmitter.

2. The vehicle according to claim 1,
wherein the predetermined signal transmitted by the second transmitter includes a preamble signal that switches the state of the receiver from the intermittent operation state to the continuous operation state, and the predetermined signal transmitted by the first transmitter has a smaller amount of data than the predetermined signal transmitted by the second transmitter.

3. The vehicle according to claim 2, further comprising a first power feeder that generates electricity by the fastening operation of the seat belt, and feeds electric power to the first transmitter, and a second power feeder that generates electricity by the preliminary operation of the seat belt, and feeds electric power to the second transmitter.
